(19) United States
(12) Patent Application Publication
(10) Pub. No.: US 2015/0280408 A1
(43) Pub. Date: Oct. 1, 2015

(54) ELECTRICAL JUNCTION BOX

(71) Applicant: SUMITOMO WIRING SYSTEMS, LTD., Yokkaichi-shi (JP)

(72) Inventor: Shuichi Anami, Yokkaichi (JP)

(21) Appl. No.: 14/432,908

(22) PCT Filed: Sep. 24, 2013
(86) PCT No.: PCT/JP2013/075740

§ 371 Date: Apr. 1, 2015

(30) Foreign Application Priority Data
Oct. 4, 2012 (JP) 2012-222256

(51) Int. Cl. H02G 3/08; H02G 3/14

(52) U.S. Cl. CPC H02G 3/081; H02G 3/14

(57) ABSTRACT

Provided is an electrical connection box with a novel structure, in which a box-shaped cover that is open downward is externally fitted from above to a main body portion including an internal circuit, and drainage capability at gaps between flange portions provided on the main body portion and the end surfaces of the peripheral walls of the cover are enhanced. A flange portion is provided with a recessed portion that is formed by a downward recessed portion of the surface of the flange portion and is formed in a projecting end surface of the flange portion, a drainage hole being formed between the recessed portion and the end surface of the peripheral wall of a cover, and a surface for defining the drainage hole includes a rough surface portion.

### BACKGROUND

1. Technical Field

Exemplary embodiments relate to an electrical connection box having a box-shaped cover that opens downward and is externally fitted from above to a main body portion including an internal circuit.

2. Background Art

Conventionally, electrical connection boxes in which electrical components such as fuses and relays are arranged with good space efficiency are used at appropriate portions in electrical systems of automobiles and the like, and thus power supply/distribution from a battery to various electrical equipment and control thereof are efficiently performed. For example, JP 2012-100476A (Patent Document 1) discloses a known example of such an electrical connection box, which has a structure in which a box-shaped cover that is open downward is externally fitted from above to a main body portion including an internal circuit configured by a printed circuit board and the like.

Incidentally, in such an electrical connection box, as shown in FIG. 5 in Patent Document 1, flange portions projecting outward in a collar shape are provided on side walls of the main body portion. The end surfaces of the peripheral walls of the cover that is externally fitted from above to the main body portion abut against the flange portions, and thus the cover is positioned with respect to the main body portion and held. Moreover, open gaps that are formed between the opposing surfaces of the peripheral walls of the cover and the side walls of the main body portion are covered with the flange portions from below, thus advantageously preventing water from entering the main body portion from below.

However, since the flange portions are formed to project outwardly in the direction orthogonal to the side walls of the main body portion, there is a problem in that, for example, when water contacts the surface of the cover due to a water splash or water that flows from the upper side to the lower side, the water is likely to accumulate on the flange portions before falling downward. In addition, since minute opposing gaps are formed between the flange portions and the end surfaces of the peripheral walls of the cover abutting against the flange portions from above as shown in FIG. 1 in Patent Document 1, there is a risk that water accumulating on the flange portions is led into the inside of the cover through the minute gaps by capillary action.

Moreover, water enters the cover through fuse attaching portions and the like that are formed as openings in the upper surface of the cover. Since the gaps between the flange portions and the end surfaces of the peripheral walls of the cover are too small, there is a risk that drainage to the outside is hindered due to surface tension of water even when attempts are made to drain water that enters the cover to the outside through the gaps.

### SUMMARY

It is an object of exemplary embodiments to provide an electrical connection box with a novel structure, in which a box-shaped cover that opens downwardly is externally fitted from above to a main body portion including an internal circuit, and the box has an enhanced drainage capability at gaps between flange portions provided on the main body portion and the end surfaces of the peripheral walls of the cover.

An exemplary embodiment is an electrical connection box including a main body portion including an internal circuit, and a cover having a box shape that is open downward and is externally fitted from above to the main body portion. The cover has a peripheral wall whose end surface is held so as to abut against a flange portion that projects outward in a collar shape from a side wall of the main body portion, wherein the flange portion is provided with a recessed portion that is formed by a downward recessed portion of a surface of the flange portion and is formed in a projecting end surface of the flange portion, a drainage hole being formed between the recessed portion and the end surface of the peripheral wall of the cover, and surfaces that define the drainage hole include a rough surface portion.

In the exemplary embodiments, at least part of the flange portion is provided with a recessed portion that is formed by a downward recessed portion of the surface of the flange portion and is formed in a projecting end surface of the flange portion, and the drainage hole is formed between the recessed portion and the end surface of the peripheral wall of the cover. Thus, a large gap is ensured in a portion between the end portion of the peripheral wall of the cover and the flange portion where the drainage hole is formed. Therefore, even when water that flows down on the surface of the cover and accumulates on the flange portions is sucked by capillary action due to the gaps between the surfaces of the flange portions and the end surfaces of the peripheral walls of the cover being small, it is possible to rapidly lead the water to the recessed portion and to drain it to the outside through the drainage hole because the end portions of the minute gaps in the peripheral direction are connected to the recessed portion. Similarly, it is possible to advantageously drain water that enters the cover to the outside through the drainage hole having the large gap.

In addition, the surfaces that define the drainage hole include the rough surface portion, thus making it possible to advantageously prevent water to be drained to the outside through the drainage hole from blocking the drainage hole due to surface tension occurring between the water and the surfaces that define the drainage hole, and to prevent the drainage from being hindered Thus, drainage capability at the gap between the flange portion and the open end portion of the cover due to the provided drainage hole is more reliably and advantageously enhanced.

It should be noted that any form can be used for the rough surface portion provided on the surfaces that define the drainage hole, as long as it can break the surface tension of water. For example, the rough surface portion can be advantageously configured by forming a projection or a projecting portion on at least one of the bottom surface and the side surfaces of the recessed portion, which constitute the surfaces that define the drainage hole, and the surfaces of the peripheral walls of the cover. Moreover, although it is sufficient that the flange portion is provided with at least one recessed portion, it is desirable to provide a plurality of recessed portions at a plurality of positions that are separated from each other in the peripheral direction of the flange portion in light of drainage capability.

Here, the main body portion may have any configuration as long as it includes an internal circuit and a cover is externally fitted thereto from above. The main body portion may be configured by a single frame body for accommodating the internal circuit or by a frame body to which a cover for covering the lower side of the frame body is attached on the lower side. Moreover, the flange portions provided on the main body portion may be formed on the frame body or on the cover on the lower side.

The rough surface portion of the drainage hole is configured by forming a rib that projects from a bottom surface of the recessed portion.

With this aspect, the rough surface portion is provided by forming the rib that projects from the bottom surface of the recessed portion, thus making it possible to enhance drainage capability while solving the problem that strength decreases due to the recessed portion being provided in the flange portion.

The rib projecting from the bottom surface of the recessed portion extends in a projection direction of the flange portion.

Since the rib provided on the bottom surface of the recessed portion extends in the projection direction of the flange, that is, in the direction in which the rib is separated away from the side wall of the main body portion, water that is led to the recessed portion is likely to be advantageously led to the outside of the flange portion along the rib, and thus drainage capability is further enhanced.

The flange portion and the end surface of the peripheral wall of the cover are inclined diagonally downward at the same inclination angle.

With this aspect, the flange portion and the end surface of the peripheral wall of the cover are inclined diagonally downward, and therefore, it is possible to advantageously lead water that tends to accumulate on the flange portion to the lower side while maintaining the ability to position and hold the main body portion and the cover. In addition, the minute gap formed between the flange portion and the end surface of the peripheral wall of the cover is also inclined diagonally downward, and therefore, water is not likely to be drawn up to the inside of the cover by capillary action. If water is led to the minute gap between the flange portion and the end surface of the peripheral portion of the cover by capillary action, water is led to the recessed portion and is rapidly drained to the outside through the drainage hole along the recessed portion that is inclined diagonally downward. Accordingly, drainage capability at the gap between the flange portion and the end surface of the peripheral wall of the cover is more advantageously and reliably enhanced.

In exemplary embodiments, the flange portion is provided with a recessed portion that is formed by a downward recessed portion of the surface of the flange portion and is formed in a projecting end surface of the flange portion, and the drainage hole is formed between the recessed portion and the end surface of the peripheral wall of the cover. This makes it possible to rapidly lead water that is led to the minute gap between the surface of the flange portion and the end surface of the peripheral surface of the cover to the recessed portion, and to drain the water to the outside through the drainage hole. In addition, the surfaces that define the drainage hole include the rough surface portion, and therefore, occurrence of surface tension between water to be drained to the outside through the drainage hole and the surfaces that define the drainage hole is advantageously prevented. Therefore, water is reliably drained through the drainage hole, and thus drainage capability at the opposing gap between the flange portion and the end surface of the peripheral wall of the cover is advantageously enhanced.

### BRIEF DESCRIPTION OF THE DRAWINGS

FIG. 1 is an exploded perspective view of an electrical connection box according to an exemplary embodiment.

FIG. 2 is an enlarged view of region A in FIG. 1.

FIG. 3 is a front view of a main body portion.

FIG. 4 is a back view of the main body portion.

FIG. 5 is an enlarged cross-sectional view of the main portions taken along line V-V in FIG. 3.

FIG. 6 is an enlarged cross-sectional view of the main portions taken along line VI-VI in FIG. 3.

FIG. 7 is a front view illustrating a state where a cover of the electrical connection box shown in FIG. 1 and the main body portion are assembled to each other.

FIG. 8 is an enlarged view of region B in FIG. 7.

FIG. 9 is an enlarged cross-sectional view of the main portions taken along line IX-IX in FIG. 7.

FIG. 10 is an enlarged cross-sectional view of main portions taken along line X-X in FIG. 7.

### DETAILED DESCRIPTION OF THE EMBODIMENTS

Hereinafter, an exemplary embodiment will be described with reference to the drawings.

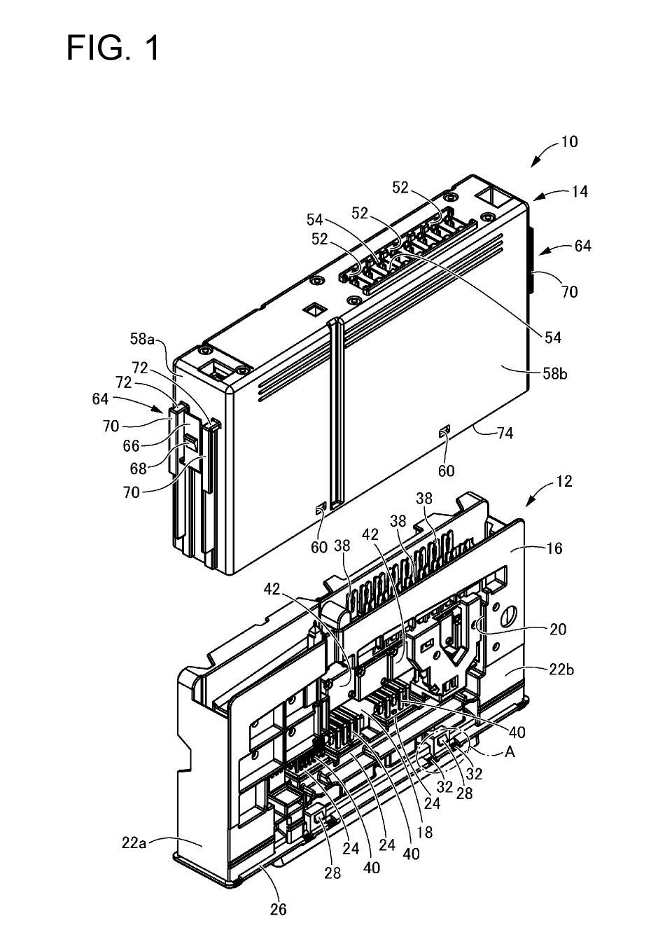

First, FIG. 1 shows an electrical connection box 10 according to an exemplary embodiment. The electrical connection box 10 includes a main body portion 12 and a cover 14. The box-shaped cover 14 that is open downward is externally fitted from above to the main body portion 12, and thus the main body portion 12 is accommodated in the cover 14 and is assembled thereto. The electrical connection box 10 is, for example, accommodated in another electrical connection box such as a relay box and is mounted to a vehicle such as an automobile.

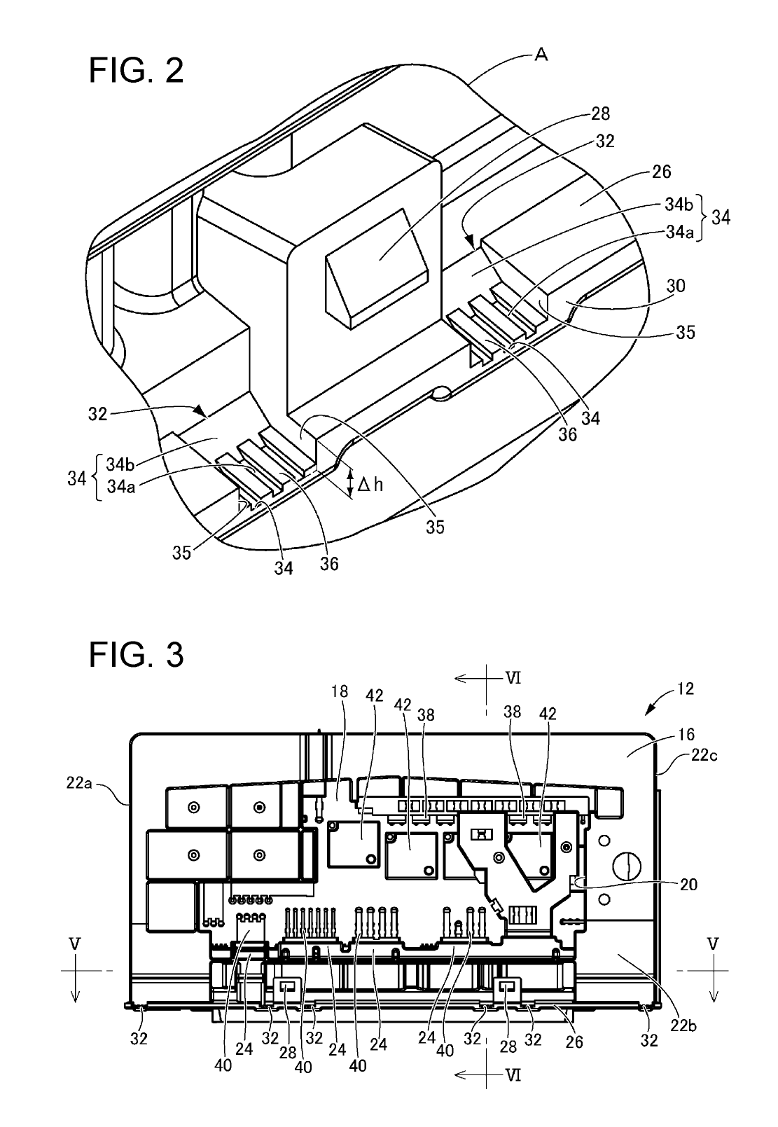

FIGS. 2 to 6 show the main body portion 12. The main body portion 12 is formed in an elongated rectangular block shape as a whole. The main body portion 12 has a structure in which a printed circuit board 18 serving as an internal circuit is assembled to a frame body 16 made of a synthetic resin. It should be noted that the internal circuit is not limited to the printed circuit board 18, and may be configured by another conductive member such as a bus bar. The main body portion 12 is mounted to a vehicle such that the up-down direction in FIG. 3 is the vertical up-down direction. The vertical direction in the following description refers to the vertical direction in FIG. 3.

The frame body 16 is formed in a substantially elongated rectangular frame shape provided with a central hole 20 that penetrates the center thereof, and has four side walls 22a, 22b, 22c, and 22d. As shown in FIG. 1, fuse terminals 38, which will be described later, are arranged in a line over substantially half of an upper surface of the frame body 16 with respect to the longitudinal direction. Moreover, a plurality of connector portions 24 through which connector terminals 40, which will be described later, are to be inserted are formed in a line in the longitudinal direction of the frame body 16 on the lower portion of the frame body 16.

Flange portions 26 are formed on the lower end portions of the side walls 22a, 22b, 22c, and 22d of the frame body 16 configuring the main body portion 12. As is clear from FIGS. 1, 3, and 4, the flange portions 26 project outward in a collar shape from the side walls 22a, 22b, 22c, and 22d of the frame body 16, and are formed in a continuous manner along substantially the entire periphery of the frame body 16.

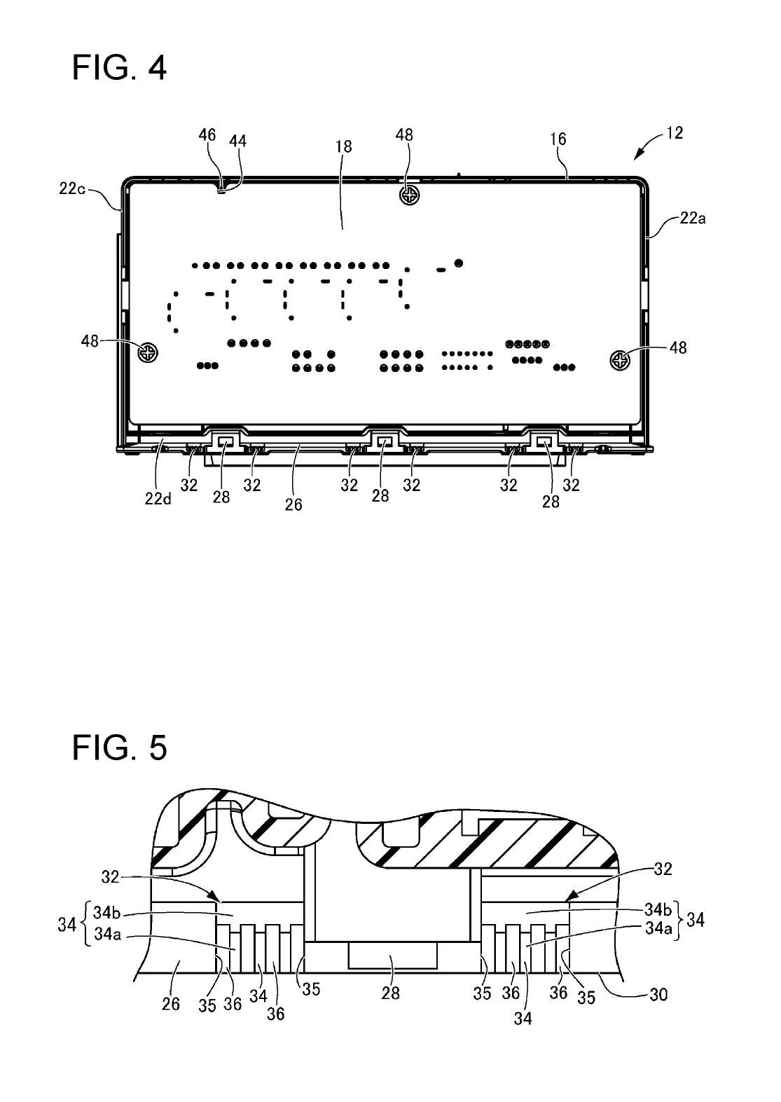

A plurality of locking claws 28 are formed on the side wall 22b (see FIG. 3) and the side wall 22d (see FIG. 4) of the frame body 16 at positions slightly above the flange portions 26. The locking claws 28 project outward from the frame body 16. The locking claws 28 are arranged with suitable gaps in the peripheral direction of the frame body 16. The side wall 22b of the frame body 16 is provided with two locking claws 28, and the side wall 22d of the frame body 16 is provided with three locking claws 28.

Furthermore, the flange portions 26 provided on the side wall 22b and the side wall 22d of the frame body 16 are provided with recessed portions 32 that are downward recessed portions of the surfaces of the flange portions 26 and are formed in projecting end surfaces 30 of the flange portions 26 at a plurality of positions that are separated in the peripheral direction (see FIGS. 2 and 5). In this embodiment, the flange portion 26 provided on the side wall 22b is provided with six recessed portions 32 in total, which are located at positions on the two sides of each of the two locking claws 28 and in the two end portions in the longitudinal direction (see FIG. 3). The flange portion 26 provided on the side wall 22d is provided with six recessed portions 32 in total, which are located at positions on the two sides of each of the three locking claws 28 (see FIG. 4).

Here, as shown by the enlarged views in FIGS. 2 and 5, each recessed portion 32 is formed by cutting out part of the periphery of the flange portion 26 from the projecting end surface 30 side to form a recessed groove shape having a substantially rectangular cross section. As shown in FIG. 2, a bottom surface 34 of the recessed portion 32 is located lower than the surface of the flange portion 26 by Δh, and is connected to the surface of the flange portion 26 via two side surfaces 35 of the recessed portion 32 so as to form a step shape. It should be noted that Δh, which refers to the height difference between the surface of the flange portion 26 and the bottom surface 34 of the recessed portion 32, can be set as desired from the viewpoint of drainage capability and water resistance.

On the bottom surface 34 of the recessed portion 32, a region extending from the substantially central portion in the projection direction of the flange portion 26 to the projecting end surface 30 serves as a first region 34a in which the separation distance from the surface of the flange portion 26 to the lower side is constant, whereas a region extending from the substantially central portion in the projection direction of the flange portion 26 to a base end portion serves as a second region 34b in which the separation distance from the surface of the flange portion 26 to the lower side gradually decreases.

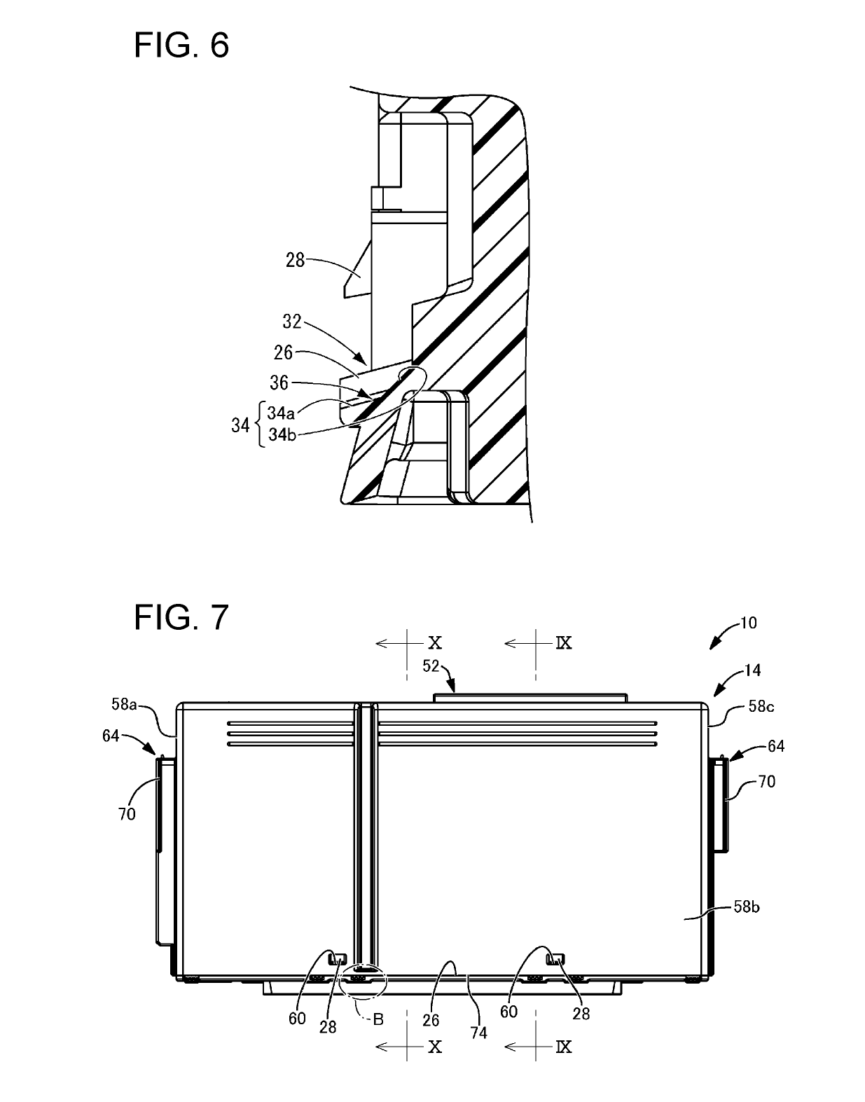

Furthermore, as shown in FIG. 6, each flange portion 26 projects while being inclined diagonally downward at a predetermined inclination angle. The first region 34a of the bottom surface 34 of the recessed portion 32 is inclined diagonally downward at the same inclination angle as that of the flange portion 26, whereas the second region 34b of the bottom surface 34 of the recessed portion 32 is inclined diagonally downward more steeply than the flange portion 26. Thus, water that enters the base end portion side of the flange portion 26 is rapidly led from the second region 34b to the first region 34a on the bottom surface 34 of the recessed portion 32 by utilizing the inclination, and drainage efficiency is enhanced.

Moreover, a plurality of (four, in this embodiment) ribs 36 project from the bottom surface 34 of the recessed portion 32. Each of the ribs 36 has a rectangular cross section, and is provided so as to extend from the second region 34b toward the first region 34a on the bottom surface 34 in the projection direction of the flange portion 26. A rough surface portion is formed on the bottom surface 34 of the recessed portion 32, which serves as a surface for defining a drainage hole 76 that will be described later, by providing the ribs 36 to project from the bottom surface 34 of the recessed portion 32 in this manner. In addition, the strength of the recessed portions 32 and the entire flange portion 26 can be secured by providing the ribs 36 to project from the bottom surfaces 34 of the recessed portions 32. It should be noted that each rib 36 extends while being inclined at the same inclination angle as that of the flange portion 26 and the first region 34a of the bottom surface 34 of the recessed portion 32 (see FIG. 6).

The printed circuit board 18 is assembled to the side wall 22d (see FIG. 4) of the frame body 16. The printed circuit board 18 is formed in an elongated rectangular plate shape extending over substantially the entire side wall 22d of the frame body 16. The printed circuit board 18 is provided with a plurality of fuse terminals 38 that are to be connected to fuses (not shown), and a plurality of connector terminals 40 that are to be connected to connectors (not shown). The fuse terminals 38 and the connector terminals 40 are formed in an L-shaped bent shape. In addition, a plurality of relays 42 are provided on the central portion of the printed circuit board 18.

When the printed circuit board 18 is assembled to the frame body 16, the printed circuit board 18 provided with the relays 42 and the side wall 22d of the frame body 16 overlap each other in a state where the fuse terminals 38 and the connector terminals 40 are respectively inserted through fuse terminal inserting holes (not shown) and the connector portions 24 in advance, for example. It should be noted that a notch 44 is formed on the periphery of the printed circuit board 18 as shown in FIG. 4, and a positioning projection 46 provided on the frame body 16 enters the notch 44 to position the printed circuit board 18 with respect to the frame body 16. Thus, the fuse terminals 38 and the connector terminals 40 are respectively inserted through the corresponding through holes of the printed circuit board 18. Then, after the printed circuit board 18 is fixed to the frame body 16 with a plurality of (three, in this embodiment) bolts 48, the fuse terminals 38 and the connector terminals 40 are fixed to the printed circuit board 18 by soldering. The main body portion 12 is configured in this manner.

On the other hand, the cover 14 is an integrally molded article made of a synthetic resin. As shown in FIG. 1, the cover 14 is formed in an elongated rectangular box shape that is open downward. On the upper surface of the cover 14, a plurality of fuse attaching portions 52 are formed so as to be aligned in a row over substantially half of the upper surface of the cover 14 with respect to the longitudinal direction. Each of the fuse attaching portions 52 is provided with a pair of terminal insertion holes 54 that are opposed to each other and penetrate the upper surface of the cover 14.

Furthermore, as is clear from FIG. 1, rectangular locking holes 60 that penetrate the cover 14 are formed at positions corresponding to the locking claws 28 of the main body portion 12 in the lower end portion of a peripheral wall 58b of the cover 14. In this embodiment, the peripheral wall 58b of the cover 14, which overlaps the side wall 22b of the frame body 16 of the main body portion 12, is provided with two locking holes 60. Similarly, although not shown in the figures, a peripheral wall 58d, which overlaps the side wall 22d of the frame body 16 of the main body portion 12, is provided with three sub-locking holes 60.

An external lock 64 is formed on each of the outer surfaces of peripheral walls 58a and 58c of the cover 14 that are opposed to each other in the longitudinal direction. The external locks 64 are formed in substantially the same shape, and therefore, the external lock 64 on the peripheral wall 58a shown in FIG. 1 will be taken as an example in the following description. The external lock 64 is provided with an elastic piece 66 that projects outward from the peripheral wall 58a in the longitudinal direction of the cover 14 and extends upward. The elastic piece 66 is provided with an engaging claw 68 that projects outward in the longitudinal direction of the cover 14. Furthermore, the external lock 64 is provided with a pair of guiding portions 70 on the two sides sandwiching the elastic piece 66. The guiding portions 70 project outward from the peripheral wall 58a in the longitudinal direction of the cover 14, and extend in the vertical direction with an L-shaped cross section formed by bending the projecting edge portion away from the cover 14 at a right angle in the direction orthogonal to the longitudinal direction of the cover 14. The lower end portions of the guiding portions 70 are located slightly lower than the lower end portion of the elastic piece 66, and the upper end portions thereof are located at substantially the same height as the upper end portion of the elastic piece 66. The lower edge portions of the guiding portions 70 are open downward, and the upper edge portions of the guiding portions 70 are provided with abutting walls 72.

As shown in FIG. 1, the cover 14 is externally fitted from above to the main body portion 12. The end surfaces 74 of the peripheral walls of the cover 14 abut against the flange portions 26 of the main body portion 12 and are held, and thus the external fitting amount of the cover 14 to the main body portion 12 is defined. Then, the locking holes 60 provided in the peripheral wall 58b of the cover 14 and the like are respectively engaged with the corresponding locking claws 28 of the main body portion 12, and thus the cover 14 is fixed to the main body portion 12. As shown in FIG. 7, the main body portion 12 and the cover 14 are thereby assembled to each other in a state where the portion of the main body portion 12 located above the flange portions 26 is accommodated in the cover 14, and thus the electrical connection box 10 is configured. Then, the fuse terminals 38 (see FIG. 1 etc.) provided on the main body portion 12 are arranged in the fuse attaching portions 52 provided on the cover 14.

In the electrical connection box 10 configured to have such a structure, fuses (not shown) are attached to the fuse attaching portions 52. The electrical connection box 10 is accommodated in another electrical connection box (not shown) such as a relay box and is fixed thereto via the external locks 64 provided on the cover 14, and thus each connector portion 24 is connected to a connector provided in another electrical connection box.

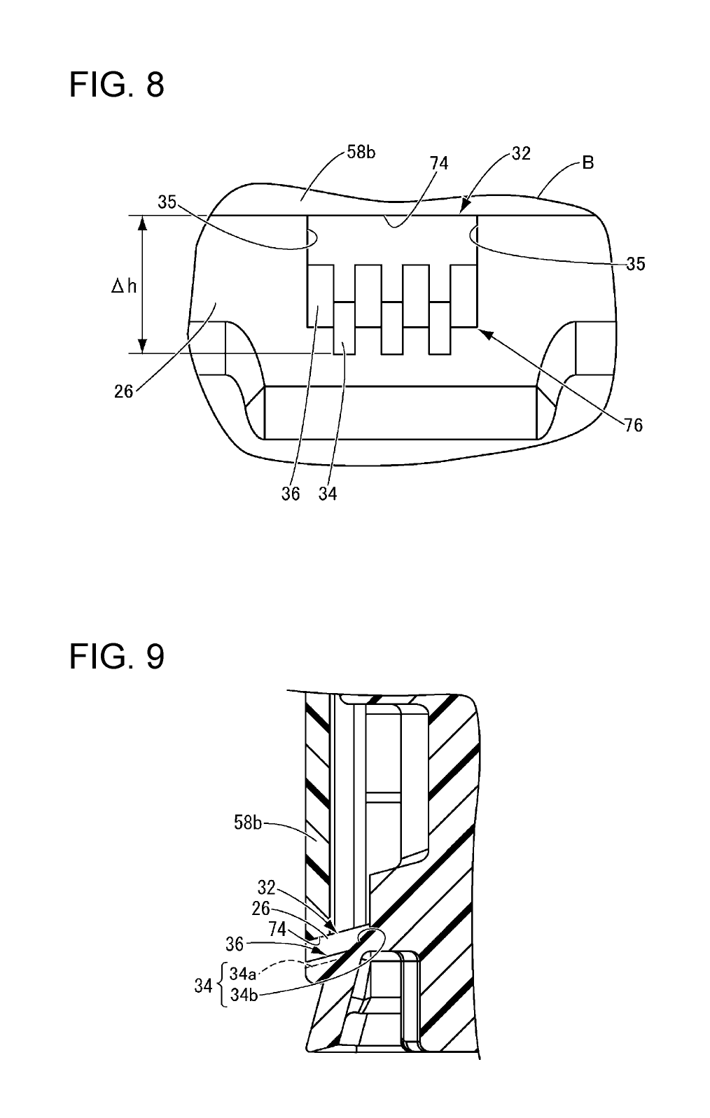

In the electrical connection box 10 having a structure according to this embodiment, as shown by the enlarged view in FIG. 8, since the bottom surface 34 of the recessed portion 32 provided in the flange portion 26 is provided to be located lower than the surface of the flange portion 26 by Δh, the dimensions of the gap formed between the abutting surfaces of the flange portion 26 and the end surface 74 of the peripheral wall of the cover 14 are made larger in the region in which the recessed portion 32 is formed. The drainage hole 76 can be thereby formed between the recessed portion 32 and the end surface 74 of the peripheral wall of the cover 14. Therefore, even if water that flows down on the surface of the cover 14 and accumulates on the flange portions 26 is sucked by capillary action due to the gaps between the surfaces of the flange portions 26 and the end surfaces 74 of the peripheral walls of the cover 14 being small, it is possible to rapidly lead the water to the recessed portions 32 that are connected to the end portions of the minute gaps in the peripheral direction and to reliably drain the water to the outside through the drainage holes 76 defined by the recessed portions 32. Moreover, even if water that enters the cover 14 reaches the position between the opposing surfaces of the flange portion 26 and the end surface 74 of the peripheral wall of the cover 14, it is possible to rapidly drain the water to the outside through the drainage holes 76 in which the opposing gaps therebetween are made larger.

In addition, since the bottom surface 34 of the recessed portion 32, which serves as a surface for defining the drainage hole 76, is provided with the rough surface portion by forming the ribs 36 that project from the bottom surface 34 of the recessed portion 32, a problem in that the drainage hole 76 is blocked by surface tension occurring between water and the surfaces that define the drainage hole 76 when the water is drained to the outside through the drainage holes 76 is advantageously solved. Therefore, it is possible to reliably enhance drainage capability between the opposing surfaces of the flange portion 26 and the end surface 74 of the peripheral wall of the cover 14. It should be noted that the surfaces that define the drainage hole 76 include the bottom surface 34 and the two side surfaces 35 of the recessed portion 32, and the end surface 74 of the peripheral wall of the cover 14.

In particular, since the ribs 36 projecting from the bottom surface 34 of the recessed portion 32 extend in the projection direction of the flange portion 26 in this embodiment, water that is led to the recessed portion 32 is reliably led to the outside of the flange portion 26 along the ribs 36, and thus drainage capability is further enhanced.

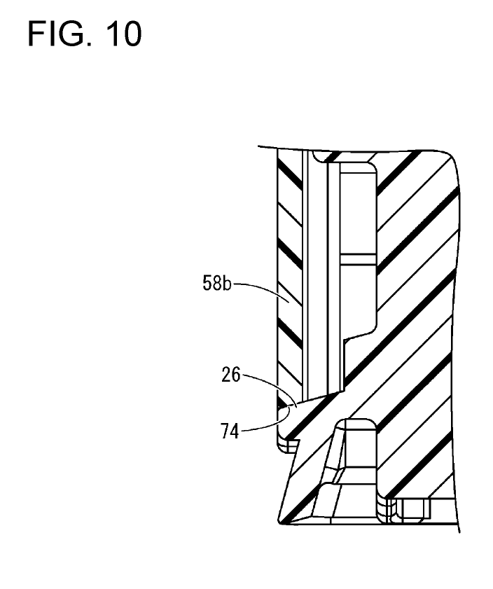

In addition, as shown in FIGS. 9 and 10, in this embodiment, the flange portions 26 and the end surfaces 74 of the peripheral walls of the cover 14 are inclined diagonally downward at the same inclination angle. This makes it possible to advantageously lead water that tends to accumulate on the flange portions 26 to the lower side, while maintaining the ability to position and hold the main body portion 12 and the cover 14 due to the contact between the flange portions 26 and the end surfaces 74 of the peripheral walls of the cover 14. As shown in FIG. 10, since the minute gaps formed between the flange portions 26 and the end surfaces 74 of the peripheral walls of the cover 14 are also inclined diagonally downward, water is not likely to be drawn up to the inside of the cover 14 by capillary action. Even if water is led to the minute gaps between the flange portions 26 and the end surfaces 74 of the peripheral walls of the cover 14 by capillary action, it is possible to more reliably drain the water that is led to the inside through the drainage holes 76 because the first region 34a on the bottom surface 34 of the recessed portion 32 to which the water is led is inclined diagonally downward at the same inclination angle and the second region 34b located on the side of the base end portion of the flange portion 26 is inclined diagonally downward at a steeper inclination angle.

Since the flange portion 26 is provided with the recessed portions 32 on the two sides of the locking claw 28 in this embodiment, it is possible to rapidly lead water that enters the cover 14 from the locking hole 60 that penetrates the peripheral wall 58b of the cover 14 and is engaged with the locking claw 28 to the recessed portion 32 and drain the water to the outside through the drainage holes 76.

Although an exemplary embodiment has been described in detail, the present invention is not limited to the specific description. For example, there is no limitation on the rough surface portion provided on the surface for defining the drainage hole 76 as long as it has a structure capable of breaking surface tension of water. The rough surface portion may be formed by providing projections or the like on the side wall 35 of the recessed portion 32 or the end surface 74 of the peripheral wall of the cover 14, for example.

Although the example in which the flange portions 26 project from the frame body 16 of the main body portion 12 is shown in the foregoing embodiment, exemplary embodiments can be carried out by providing the flange portions 26 to project from a cover on the lower side in the case where the cover on the lower side is attached to the main body portion 12 from below.

It should be noted that the number and the positions of the recessed portions 32 provided in the flange portion 26, the number and the shape of the ribs 36 provided in the recessed portion 32, and the like can be set as desired considering the individual circumstances from the viewpoint of drainage capability and water resistance.

What is claimed is

1. An electrical connection box comprising:
a main body portion including an internal circuit; and
a cover having a box shape that opens downwardly and is externally fitted from above to the main body portion, the cover having a peripheral wall whose end surface is held so as to abut against a flange portion that projects outward in a collar shape from a side wall of the main body portion,
wherein:
the flange portion is provided with a recessed portion that is formed by a downward recessed portion of a surface of the flange portion and is formed in a projecting end surface of the flange portion, a drainage hole being formed between the recessed portion and the end surface of the peripheral wall of the cover, and surfaces that define the drainage hole include a rough surface portion.

2. The electrical connection box according to claim 1,
wherein the rough surface portion of the drainage hole is configured by forming a rib that projects from a bottom surface of the recessed portion.

3. The electrical connection box according to claim 2,
the rib projecting from the bottom surface of the recessed portion extends in a projection direction of the flange portion.

4. The electrical connection box according to claim 1, wherein the flange portion and the end surface of the peripheral wall of the cover are inclined diagonally downward at the same inclination angle.
